(19) United States
(12) Patent Application Publication
(10) Pub. No.: US 2025/0351142 A1
(43) Pub. Date: Nov. 13, 2025

(54) RACH PROCEDURES FOR NON-TERRESTRIAL NETWORKS FOR BASE STATION

(71) Applicant: Apple Inc., Cupertino, CA (US)

(72) Inventors: Chunhai YAO, Beijing (CN); Oghenekome OTERI, San Diego, CA (US); Chunxuan YE, San Diego, CA (US); Dawei ZHANG, Saratoga, CA (US); Haitong SUN, Saratoga, CA (US); Hong HE, San Jose, CA (US); Sigen YE, San Diego, CA (US); Wei ZENG, Saratoga, CA (US); Weidong YANG, San Diego, CA (US); Yushu ZHANG, Beijing (CN); Sarma V. VANGALA, Campbell, CA (US); Haijing HU, Los Gatos, CA (US)

(21) Appl. No.: 19/275,853

(22) Filed: Jul. 21, 2025

Related U.S. Application Data
(63) Continuation of application No. 17/598,230, filed on Sep. 24, 2021.

(51) Int. Cl. H04W 72/21; H04W 74/0833

(52) U.S. Cl. CPC H04W 72/21; H04W 74/0833

(57) ABSTRACT

Methods and systems to enhance NR RACH procedure to accommodate non-terrestrial networks (NTN) are disclosed. The length of the RAR window may be extended. In one aspect, a gNB of the NTN may perform blind retransmissions of the RAR message scheduled by DCI within the RAR window to user equipment to improve transmission reliability of the RAR message for NTN. The number of blind retransmission and the transmission pattern may depend on the PRACH reception condition, an uplink channel condition, or may be pre-configured. In one aspect, the gNB may extend the K1 value and K2 value that determine the delays between uplink and downlink transmissions to align the time domain duplex (TDD) uplink-downlink configuration due to the long propagation delays associated with the NTN. In one aspect, the gNB may broadcast or multicast RAR window size extension values to the UEs based on the orbital altitude of the satellites.

### RELATED APPLICATIONS

The present application is a continuation of U.S. application Ser. No. 17/598,230, filed Sep. 24, 2021 and published on May 18, 2023 as U.S. Publication No. 2023-0156707, which is the national phase of International Application No. PCT/CN2020/107242, filed on Aug. 5, 2020 and the disclosures of which are hereby incorporated herein by reference in their entireties.

### FIELD

This disclosure relates to the field of wireless communication, and more specifically, to methods and systems that enable wireless communication devices to perform random access channel (RACH) procedures to non-terrestrial networks. Other aspects are also described.

### BACKGROUND

As the number of mobile devices connected to wireless networks and the demand for mobile data traffic continue to increase, changes are made to system requirements and architectures to meet current and anticipated burgeoning demand. For example, wireless communication networks such as the 5G new radio (NR) systems may need to be deployed using satellites as parts of a non-terrestrial network (NTN). In one deployment scenario of a NTN, a satellite referred to as a transparent satellite may act as a relay station to link user devices with a ground-based base station and the 5G core network by implementing a transparent payload. In another deployment scenario, a satellite referred to as a regenerative satellite may have onboard processing capability to perform the functions of a base station by implementing a regenerative payload between the user devices and the ground-based 5G core network. Due to the wide coverage area of the satellites and the long distances between the satellites and the user devices on the ground, the difference in propagation delays between two user devices within the beam footprint is greater than that encountered in strictly terrestrial networks. For example, for a NTN deploying satellites in a geosynchronous earth orbit (GEO), the maximum differential delay between points at a nadir and edge of the coverage may be 10.3 ms. For a NTN deploying satellites in a low earth orbit (LEO), the maximum differential delay may be 3.12 ms and 3.18 ms for 600 km and 1200 km altitude, respectively.

The large propagation delay of a user device and the large difference in propagation delays between user devices in the beam footprint may cause problems when the user devices execute a contention-based RACH procedure to gain initial access to the NTN. A user device may initiate the RACH procedure by sending a physical random access channel (PRACH) transmission to a base station. The user device may send the PRACH transmission as a preamble during a system frame using time-frequency resources that are uniquely associated with a random access radio network temporary identifier (RA-RNTI) of the user device. The base station may derive the RA-RNTI of the user device transmitting the PRACH from the time-frequency resources carrying the PRACH and may send a random access response (RAR) whose scheduling downlink control information (DCI) cyclic redundancy check (CRC) is scrambled by the RA-RNTI to identify RAR as intended for the user device. The user device may search for the RAR in a common search space by attempting to decode the RAR using its RA-RNTI. When the user device successfully decodes the RAR, the user device may transmit using uplink resources granted by the RAR to attempt to gain access to the network.

The common search space, referred to as a RAR window, during which the user device searches for the RAR may be only one frame in duration, which may not be long enough to accommodate the maximum differential delay of user devices executing the RACH procedure in a NTN. If the RAR window is extended, there may be further ambiguities for the user device to determine if a RAR is intended for it because the RAR window may contain multiple RARs generated in response to multiple user devices with the same RA-RNTI transmitting PRACHs using identical time-frequency resources in different system frames spanning the maximum differential delay. That is, multiple RARs within the RAR window may have their CRC scrambled by the same RA-RNTI, making it difficult for a user device to determine if it is the intended recipient of the RAR. Other complications may arise for the RACH procedure in NTN including determining whether and how to delay the start of the RAR window due to the long maximum propagation delay.

SUMMARY

Methods and systems to enhance NR RACH procedure to accommodate non-terrestrial networks (NTN) are disclosed. Modifications may be made to the RACH procedure from the user equipment (UE) or from the base station, referred to as ‘gNodeB’ or ‘gNB’ of 5G NR. The start of the RAR window and the length of the RAR window may be extended depending on the range of propagation delays (e.g., LEO or GEO satellites). When the length of the RAR window is extended, a NTN-RNTI associated with the time-frequency resources used for the PRACH preamble may be used to scramble the CRC of the downlink control information (DCI) format 1_0 used for downlink assignment in the RAR. The DCI format 1_0 content may include information on the associated PRACH preamble to assist the UE in distinguishing between RARs generated as a response to PRACH preambles transmitted by different UEs from different system frames based on the same RA-RNTI. In one aspect, the NTN-RNTI may contain information on the system frames when the UE sends the PRACH preamble. In one aspect, RA-RNTI associated with the time-frequency resources used for the PRACH preambles transmitted from different frames may be used to scramble different subsets of the CRC of the DCI format 1_0 to assist the UE in distinguishing between RARs generated in response to the different PRACH preambles.

In one aspect, the UE may perform blind retransmissions of the PRACH preamble to indicate the extension of the RAR window. In one aspect, the UE may change the RAR window offset that determines the start of the RAR window from the end of the PRACH preamble transmission based on the knowledge of the location information and thus the propagation delay of the UE.

In one aspect, the gNB may perform blind retransmissions of the RAR within the RAR window to improve transmission reliability for NTN. The number of blind retransmission and the transmission pattern may depend on the PRACH reception condition, an uplink channel condition, or may be pre-configured. In one aspect, the gNB may extend the K1 value and K2 value that determine the delays between uplink and downlink transmissions to align the time domain duplex (TDD) uplink-downlink configuration due to the long propagation delays associated with the NTN. In one aspect, the gNB may broadcast or multicast RAR window size extension values to the UEs based on the orbital altitude of the satellites.

The above summary does not include an exhaustive list of all aspects of the present disclosure. It is contemplated that aspects of the disclosure include all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 illustrates an example wireless communication system in accordance with some aspects of the disclosure.

FIG. 2 illustrates a base station (BS) in communication with a user equipment (UE) device in accordance to some aspects of the disclosure.

FIG. 3 illustrates an example block diagram of a UE in accordance with some aspects of the disclosure.

FIG. 4 illustrates an example block diagram of a BS in accordance with some aspects of the disclosure.

FIG. 5 illustrates an example block diagram of cellular communication circuitry in accordance with some aspects of the disclosure.

FIG. 6 illustrates a DCI field-based RAR window size extension in accordance with some aspects of the disclosure.

FIG. 7 illustrates a RNTI-based RAR window size extension in accordance with some aspects of the disclosure.

FIG. 8 illustrates PRACH blind retransmissions over multiple frame numbers by the UE to indicate extension of the RAR window size in accordance with some aspects of the disclosure.

FIG. 9 illustrates the use of RA-RNTI to mask different positions of DCI in accordance with some aspects of the disclosure.

FIG. 10 illustrates a timing relationship in NTN between the base station and the UE using a timing advance adjustment for the UE based on the round trip propagation delay between the base station and the UE.

FIG. 11 is a data flow diagram illustrating an example of a method for a UE to transmit PRACH preamble to a base station and to receive a RAR message from the base station over an extended RAR window to perform the RACH procedure in accordance with some aspects of the disclosure.

FIG. 12 is a flow diagram illustrating an example of a method for a base station to receive PRACH preamble from a UE, to determine the RNTI, and to transmit a RAR based on the RNTI over an extended RAR window to the UE in accordance with some aspects of the disclosure.

### DETAILED DESCRIPTION

Disclosed are techniques to enhance NR RACH procedure to accommodate non-terrestrial networks (NTN) or other networks with long propagation delays. The start of the RAR window and the length of the RAR window used for the RACH procedure may be extended depending on the range of propagation delays (e.g., LEO or GEO satellites). The RNTI associated with the time-frequency resources used for the PRACH preamble and the frame number of the transmission of the PRACH by a UE may be used to scramble the CRC of DCI format 1_0 in the RAR to assist the UE in distinguishing between the RAR intended for the UE from RARs generated as a response to PRACH preambles transmitted by other UEs during different system frames.

In one aspect, a method for accessing a NTN by a UE is disclosed. The method includes the UE transmitting to a base station of the NTN, such as a gNB of 5G NR, a PRACH preamble during a frame to request access to the NTN. The frame may be part of a frame structure that includes a number of frames. The method also includes the UE receiving a RAR message from the base station during a RAR window. The RAR window may span a number of frames of the frame structure. The method further includes the UE determining whether the RAR message received from the base station is intended for the UE based on an indication in a downlink control information (DCI) that schedules the RAR message.

In one aspect, a method for granting access to a NTN by a base station, such as a gNB of 5G NR, to a request from a UE is disclosed. The method includes the base station receiving from the UE a PRACH preamble during a frame to request access to the NTN. The method also includes the base station determining the RNTI from the time-frequency resources of the frame used for carrying the PRACH preamble. The method further includes the base station transmitting during a RAR window that spans a number of frames a RAR message. The RAR message is scheduled by a DCI that includes an indication to allow the UE to determine that the RAR message is intended for the UE based on the RNTI and the frame number of the frame used for carrying the PRACH preamble.

In the following description, numerous specific details are set forth. However, it is understood that aspects of the disclosure here may be practiced without these specific details. In other instances, well-known circuits, structures and techniques have not been shown in detail in order not to obscure the understanding of this description.

The terminology used herein is for the purpose of describing particular aspects only and is not intended to be limiting of the aspects of the disclosure. Spatially relative terms, such as “beneath”, “below”, “lower”, “above”, “upper”, and the like may be used herein for case of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and “comprising” specify the presence of stated features, steps, operations, elements, or components, but do not preclude the presence or addition of one or more other features, steps, operations, elements, components, or groups thereof.

The terms “or” and “and/or” as used herein are to be interpreted as inclusive or meaning any one or any combination. Therefore, “A, B or C” or “A, B and/or C” mean any of the following: A; B; C; A and B; A and C; B and C; A, B and C.” An exception to this definition will occur only when a combination of elements, functions, steps or acts are in some way inherently mutually exclusive.

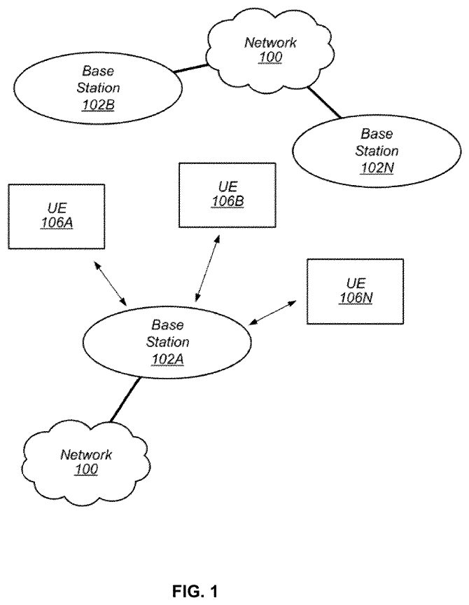

FIG. 1 illustrates a simplified example wireless communication system, according to some aspects. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N. In one aspect, the base station 102A may be deployed as a satellite, referred to as a regenerative satellite, that carries onboard processing capability to perform the functions of a base station to implement a regenerative payload between the UEs and a ground-based core network.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, CHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB.’

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible. A UE 106 may measure the time of arrival (TOA) of positioning reference signals (PRS) transmitted by its serving base station 102A and by base stations 102B-N of the neighboring cells to support position determination of UE 106.

In some aspects, base station 102A may be a next generation base station, e.g., a 5G New Radio (5G NR) base station, or “gNB”. In some aspects, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

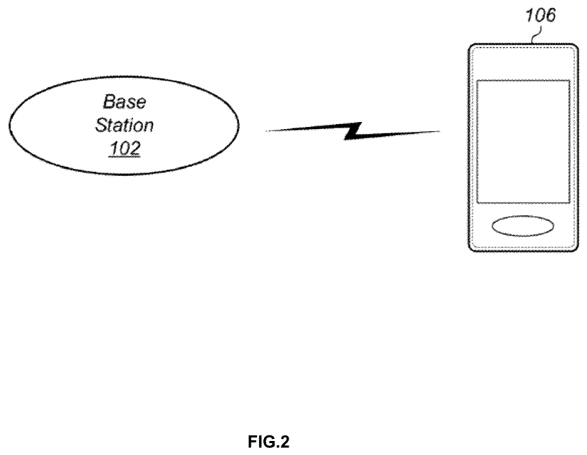

FIG. 2 illustrates user equipment 106 (e.g., one of the devices 106A through 106N) in communication with a base station 102, according to some aspects. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method described herein by executing such stored instructions. Alternatively, or in addition, the UE 106 may include a programmable hardware element such as an FPGA (field-programmable gate array) that is configured to perform any of the method described herein, or any portion of any of the method described herein.

The UE 106 may include one or more antennas for communicating using one or more wireless communication protocols or technologies. In some aspects, the UE 106 may be configured to communicate using, for example, CDMA2000 (1xRTT/1xEV-DO/HRPD/eHRPD) or LTE or 5G NR using a single shared radio and/or GSM or LTE or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTTor LTE or GSM), and separate radios for communicating using each of Wi-Fi and Bluetooth. Other configurations are also possible.

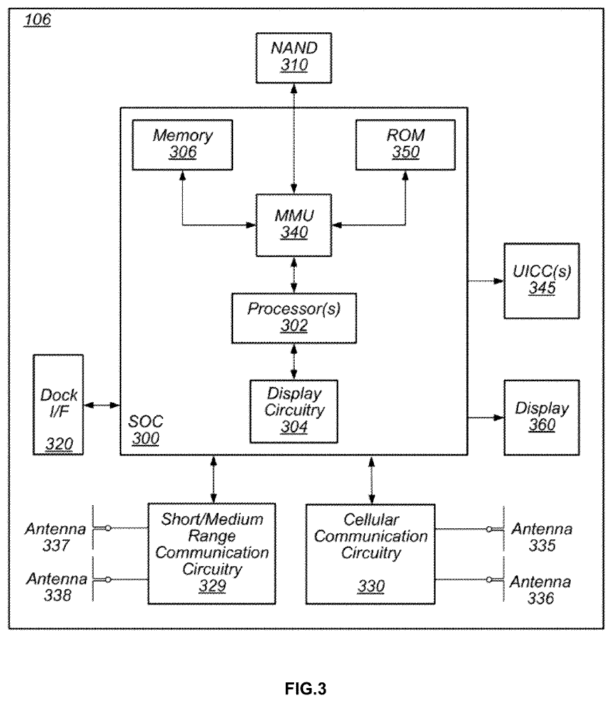

FIG. 3 illustrates an example simplified block diagram of a communication device 106, according to some aspects. It is noted that the block diagram of the communication device of FIG. 3 is only one example of a possible communication device. According to aspects, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some aspects, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some aspects, as further described below, cellular communication circuitry 330 may include dedicated receive chains (including and/or coupled to, e.g., communicatively directly or indirectly, dedicated processors and/or radios) for multiple RATs (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT and transmit an indication that the wireless device is capable of maintaining substantially concurrent connections with the first network node and a second network node that operates according to the second RAT. The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing the above features for time division multiplexing UL data for NSA (Non-Standalone) NR operations. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware clement, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

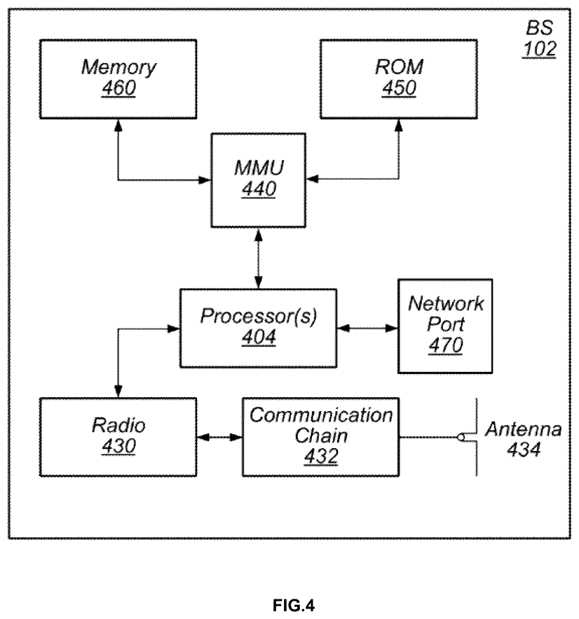

FIG. 4 illustrates an example block diagram of a base station 102, according to some aspects. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB”. In such aspects, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNB's.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.). As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware clement, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

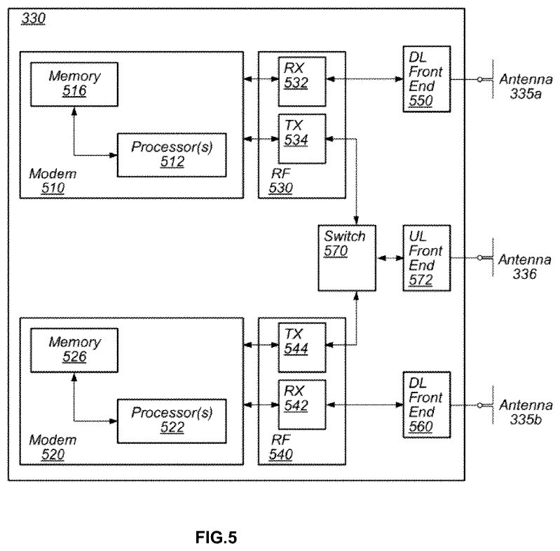

FIG. 5 illustrates an example simplified block diagram of cellular communication circuitry, according to some aspects. It is noted that the block diagram of the cellular communication circuitry of FIG. 5 is only one example of a possible cellular communication circuit. According to aspects, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some aspects, cellular communication circuitry 330 may include dedicated receive chains (including and/or coupled to, e.g., communicatively, directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335 a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335 b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for time division multiplexing UL data for NSA NR operations, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware clement, such as an FPGA (Field Programmable Gate Array), or as an ASIC (Application Specific Integrated Circuit). Alternatively (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

In 5G NR, a UE may initiate a RACH procedure to gain initial access to the network. In a 4-step contention based RACH procedure, a UE may send a PRACH to a base station in a first step. The PRACH, which may also be referred as Msg1, or a PRACH preamble, may contain 1 out of 64 preambles (long or short preambles) sent in a RACH occasion (RO). The UE may power ramp the PRACH after each failed PRACH transmission. The UE may transmit the PRACH in a frame using time-frequency resources that are uniquely associated with the RA-RNTI of the UE. For example, the RA-RNTI may be determined from the index of the first orthogonal frequency division multiplexing (OFDM) symbol of the PRACH, the index of the first slot of the PRACH in the transmitted frame, the index of the PRACH in the frequency domain, etc. There is a chance that more than one UE is transmitting the same PRACH on the same time-frequency resources in a frame.

The UE may transmit the PRACH using a timing advance (TA) adjustment to account for the propagation delay from the UE to the base station so that the PRACH when received by the base station is time aligned with the system frame structure. The UE may autonomously acquire the UE-specific TA based on its known location and satellite ephemeris. Alternatively, the base station may broadcast a common TA based on a reference point in a satellite beam or cell. The base station may also transmit a UE-specific differential TA based on network indication to the UE for the UE to derive the full TA as the sum of the common TA and the differential TA.

In a second step of the RACH procedure, in response to the PRACH from the UE, the base station may send the RAR, which may also be referred as Msg2, or a RAR message. The base station may derive the RA-RNTI of the user device transmitting the PRACH from the time-frequency resources carrying the PRACH. The RAR may be scheduled by DCI format 1_0 carried on physical downlink control channel (PDCCH) with CRC scrambled by the RA-RNTI. The UE may attempt to decode the DCI format 1_0 using its RA-RNTI in the common search space of a RAR window. The RAR may also contain media access control physical data unit (MAC PDU) carried on physical downlink shared channel (PDSCH) specified by the DCI format 1_0. The subhead of the MAC PDU may contain a 6-bit random access preamble ID (RAPID) or a 4-bit back-off indicator (BI). The MAC PDU may contain a 12-bit timing advance (TA) command, 27-bit uplink grant, and 16-bit temporary cell-RNTI (TC-RNTI). The TC-RNTI may be used by the UE for the rest of the RACH procedure.

The UE may search for the RAR during the common search space of a RAR window. The RAR window may start after Msg1 and may last up to 1 frame, or 10 ms. Because more than one UE may have transmitted the same PRACH on the same time-frequency resources in a frame, multiple UEs may attempt to decode the DCI format 1_0 of the PDCCH with CRC scrambled by the same RA-RNTI. Thus, multiple UEs may decode the DCI format 1_0, obtain the MAC PDU of the RAR from the PDSCH specified by the DCI format 1_0, and contend for access to the network.

In a third step of the RACH-procedure, after the UE receives the RAR, the UE may send a control element, which may be referred to as Msg3, on the physical uplink shared channel (PUSCH) allocated by the RAR. The UE may use the TC-RNTI received in the RAR for scrambling Msg3. The Msg3 may contain the cell-RNTI (C-RNTI), a unique identification of the UE used by the base station to allocate the UE with uplink grants, downlink assignments, etc. If the base station fails to decode Msg3, the base station may reschedule retransmission of Msg3 using DCI format 0_0 of PDCCH with CRC scrambled by TC-RNTI.

In a fourth step of the RACH-procedure, after the base station decodes Msg3, the base station may send a contention resolution identity MAC control element in Msg4. The Msg4 may be carried on PDSCH specified by the DCI format 1_0 of PDCCH with CRC scrambled by TC-RNTI. The TC-RNTI may be promoted to C-RNTI for the UE that wins the contention and does not already have a C-RNTI. If the UE successfully completes the RACH procedure and already has a C-RNTI, it may resume using its C-RNTI and may discard the TC-RNTI received in the RAR. The UE may transmit a hybrid automatic repeat request acknowledgement (HARQ-ACK) signal on PUCCH after decoding Msg4.

To expedite the RACH procedure, 5G NR introduces a 2-step RACH procedure. In a first step of the 2-step RACH procedure, the UE may send MsgA containing PRACH and PUSCH. The RACH occasion (RO) used for the PRACH and the PUSCH occasion (PO) used for the PUSCH may have fixed resource mapping. The PO map not overlap with the RO. The RO configured for the 2-step RACH may be separate or shared with the RO configured for the 4-step RACH. The PUSCH may contain scrambling sequence initialization value that depends on RA-RNTI and RAPID, and radio resource control (RRC) connection request with or without additional uplink data.

In a second step of the 2-step RACH procedure, in response to receiving MsgA, the base station may send a RAR, referred to as MsgB. The MsgB may contain PDCCH and PDSCH containing either a successful RAR MAC when the PUSCH is received successfully by the base station, or a fallback RAR MAC otherwise. The successful RAR MAC may contain contention resolution ID, TA, C-RNTI, etc. The fallback RAR Mac may contain the back-off indicator for the UE to retransmit the PRACH and PUSCH of MsgA. The UE may search for the MsgB in a RAR window. The RAR window may start after MsgA PUSCH transmission and may last up to 4 frames, or 40 ms.

The PDCCH of MsgB may include DCI format 1_0 with CRC scrambled by the C-RNTI if the UE is in connected mode. Otherwise, the CRC of the DCI format 1_0 is scrambled by a MsgB-RNTI. The UE may attempt to decode the DCI format 1_0 specifying the PDSCH containing the successful RAR MAC or the fallback RAR MAC using the MsgB-RNTI or the C-RNTI in the RAR window.

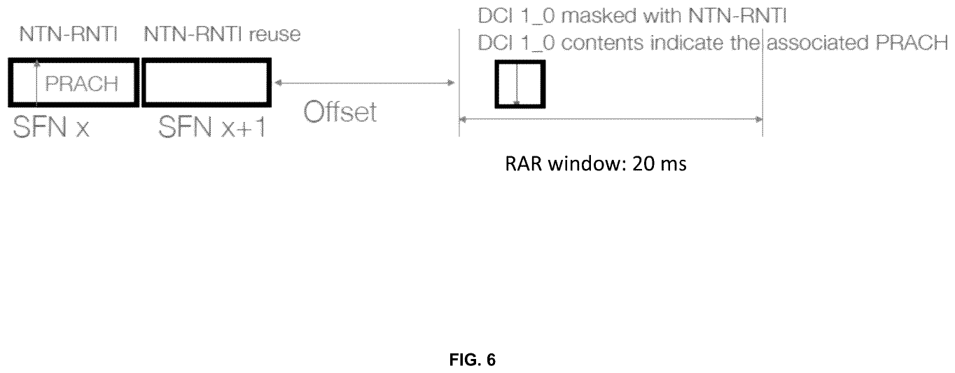

FIG. 6 illustrates a DCI field-based RAR window size extension in accordance with one aspect of the disclosure. The RAR window size may be extended for the 4-step RACH procedure depending on whether a satellite in NTN is a LEO satellite or a GEO satellite. For a LEO satellite, the maximum differential delay may be 3.12 ms and 3.18 ms for a satellite altitude of 600 km and 1200 km, respectively. Because 2 times the maximum differential delay is less than the nominal 10 ms of the RAR window, no extension of the RAR window may be necessary. However, for a GEO satellite, the maximum differential delay between points at a nadir and edge of the coverage may be 10.3 ms. Extension of the RAR window size may be needed since 2 times the maximum differential delay is close to 20 ms, or 2 frames.

In one aspect, if the RAR window size is extended to 20 ms for a GEO satellite, the DCI field may indicate the RAR window size extension. In Msg2 transmission, the CRC of DCI format 1_0 may be scrambled by a new NTN-RNTI in the common search space. Similar to RA-RNTI, the NTN-RNTI may be determined from the time-frequency resources used to transmit the PRACH in the RACH occasion. In one aspect, NTN-RNTI may be determined from the starting symbol index s_id of the PRACH, the starting slot index t_id of the PRACH in the transmitted frame, the frequency domain index f_id and the uplink carrier ul_carrier_id used for carrying the PRACH, but with an additional offset so that NTN-RNTI is different from MsgB-RNTI of the 2-step RACH procedure. For example, NTN_RNTI may be equal to (1+s_id+14×t_id+14×80×f_id+14×80×8×ul_carrier_id+14×80×8×4). The range of NTN-RNTI may then be 35841-53760, to avoid value conflict with the range of RA-RNTI of 1-17920 and the range of MsgB-RNTI of 17921-35840. DCI format 1_0 additionally has a field to indicate the least significant bit of the system frame number (SFN) when the PRACH that triggers the DCI format 1_0 is transmitted.

The UE has knowledge of the NTN-RNTI and the SFN when the PRACH is transmitted. Thus, the UE may decode DCI format 1_0 using its NTN-RNTI. The UE may also verify that the bit field in DCI format 1_0 indicating the last bit of the SFN associated with the PRACH that triggers the DCI format 1_0 matches the last bit of the SFN when the UE transmits the PRACH. The UE may thus determine if the RAR received during the extended RAR window is intended for the UE as distinguished from a RAR intended for another UE that transmits a PRACH using the same time-frequency resources but on a different frame. For example, if the UE transmits the PRACH during the frame with SFN x (e.g., even frame number), and another UE transmits the same PRACH during the following frame with SFN x+1 (e.g., odd frame number) using the same time-frequency resources so that the CRC of DCI format 1_0 of the RARs for both UEs may be scrambled by the same NTN-RNTI in the common search space. However, the two DCI format 1_0 may contain a field for the DCI indicating that the PRACHs that triggers the two RARs were transmitted on two consecutive frames. The UE that transmits the PRACH on SFN x may then verify that the field in the DCI format 1_0 indicates an even frame to determine that the DCI format 1_0 is intended for the UE so that UE may receive the correct RAR.

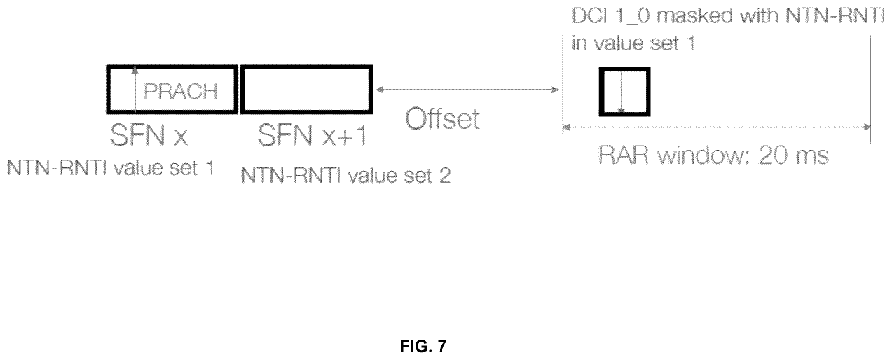

FIG. 7 illustrates a RNTI-based RAR window size extension in accordance with another aspect of the disclosure. Again, the RAR window size is extended to 20 ms for a GEO satellite. In Msg2 transmission, the CRC of DCI format 1_0 may be scrambled by a new NTN-RNTI in the common search space. However, unlike the DCI field-based RAR window size extension of FIG. 6, the NTN-RNTI here may encode the least significant bit of the SFN when the PRACH that triggers the DCI-field is transmitted. For example, the NTN_RNTI may be equal to (1+s_id+14×t_id+14×80×f_id+14×80×8×ul_carrier_id+14×80×8×4×(SFN mode 2)). The result is that if the RACH occasion is in even-numbered SFN, then NTN-RNTI reduces to RA-RNTI. On the other hand, if the RACH occasion is in odd-numbered SFN, then NTN-RNTI uses new values different from RA-RNTI. This avoids the value conflict with MsgB-RNTI, but reuses the values of RA-RNTI. That is, the NTN-RNTI range may be set to [1,17920] (set 1) for even-numbered SFN, and [35841, 53760] (set 2) for odd-numbered SFN.

In one aspect, to reuse the value range of MsgB-RNTI, the NTN_RNTI may be equal to (1+s_id+14×t_id+14×80×f_id+14×80×8×ul_carrier_id+14×80×8×2×(SFN mode 2)). The range of NTN-RNTI may then be [1, 35840], or [1, 17920] for set 1 and [17921, 35840] for set 2. Also, unlike the DCI field-based RAR window size extension of FIG. 6, the DCI format 1_0 no longer indicates the least significant bit of the system frame number (SFN) when the PRACH that triggers the DCI format 1_0 is transmitted. The UE may calculate NTN_RNTI based on the time-frequency resources of its RACH occasion and the SFN when it sends the PRACH, and may use the NTN-RNTI to determine if the RAR received during the extended RAR window is intended for the UE. For example, if the UE transmits the PRACH during the frame with SFN x, and another UE transmits the same PRACH during the following frame with SFN x+1 using the same time-frequency resources, the CRC of DCI format 1_0 of the RARs for both UEs may be scrambled by different NTN-RNTI in the common search space. The UE that transmits the PRACH on SFN x may then use its corresponding NTN-RNTI to decode the DCI format 1_0 to determine that that DCI format 1_0 is intended for the UE so that UE may receive the correct RAR.

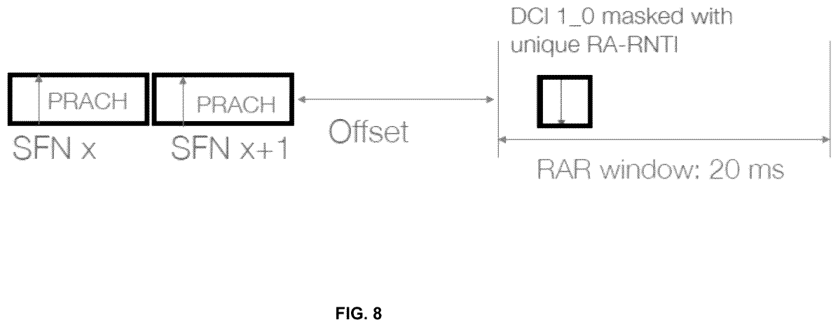

FIG. 8 illustrates PRACH blind retransmissions over multiple frame numbers by the UE to indicate extension of the RAR window size in accordance with another aspect of the disclosure. Again, the RAR window size is extended to 20 ms for a GEO satellite. In Msg1 transmission, the UE transmits multiple (e.g., 2) PRACH transmissions in the same RACH occasion (using the same time-frequency resources) repeated over multiple frames. In one aspect, the transmit power of the PRACH retransmissions may be progressively increased or remain the same. After retransmissions, the preamble power ramping counter may be increased by 1 or may be increased by the number of PRACH blind retransmissions. The same RA-RNTI is obtained from each of the PRACH retransmissions. That is, RA-RNTI may be equal to (1+s_id+14×t_id+14×80×f_id+14×80×8×ul_carrier_id). In one aspect, the RACH occasions are paired among multiple (e.g., 2) consecutive frames. For example, each UE may transmit the PRACH over two consecutive frames, the first PRACH in even SFN (SFN x) and the second PRACH in odd SFN (SFN x+1). This avoids the one-frame staggered PRACH transmissions from two different UEs. Each UE may wait in its own RAR window of 20 ms to receive the RAR message by decoding the DCI format 1_0 with its unique RA-RNTI.

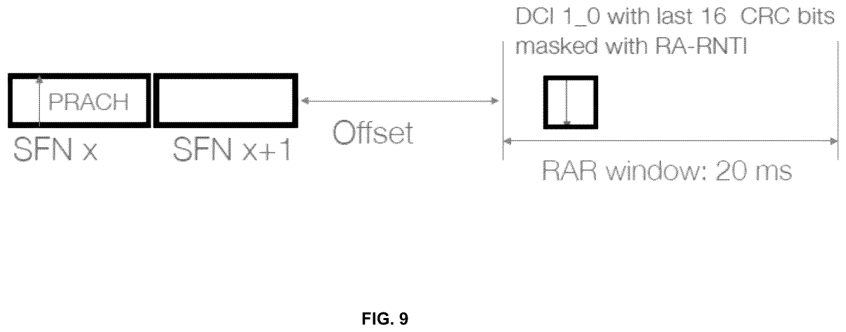

FIG. 9 illustrates the use of RA-RNTI to mask different positions of DCI CRC in accordance with another aspect of the disclosure. Again, the RAR window size is extended to 20 ms for a GEO satellite. In Msg2 transmission, different subsets of CRC of DCI format 1_0 may be scrambled by RA-RNTI in the common search space depending on the frame number when the PRACH that triggers the DCI format 1_0 is transmitted. RA-RNTI may be equal to (1+s_id+14×t_id+14×80×f_id+14×80×8×ul_carrier_id). If the last 16 bits of CRC of DCI format 1_0 is scrambled by the RA-RNTI, also referred to as masking the last 16 CRC bits of DCI format 1_0 with RA-RNTI, then the DCI format 1_0 corresponds to the PRACH transmitted using RACH occasion in even-numbered SFN. If the second last 16 bits of CRC of DCI format 1_0 is scrambled by the RA-RNTI, also referred to as masking the second last 16 CRC bits of DCI format 1_0 with RA-RNTI, then the RAR corresponds to the PRACH transmitted using RACH occasion in odd-numbered SFN.

The UE may calculate RA-RNTI based on the time-frequency resources of its RACH occasion and may determine the SFN when it sends the PRACH. The UE may use the least significant bit of the SFN to determine which 16 bits of the CRC of the DCI format 1_0 received during the extended RAR window to decode using the RN-RNTI to determine if the RAR is intended for the UE. For example, if the UE transmits the PRACH during the frame with SFN x, and another UE transmits the same PRACH during the following frame with SFN x+1 using the same time-frequency resources, different subsets of CRC of DCI format 1_0 of the RARs for the two UEs may be scrambled by the same RA-RNTI in the common search space. The UE that transmits the PRACH on SFN x may then decode the last 16 CRC bits of the DCI format 1_0 to determine that that DCI format 1_0 is intended for the UE so that UE may receive the correct RAR.

In one aspect, the RAR window offset for the RACH procedure may be modified. The RAR window offset may be modified for both the 4-step RACH procedure and the 2-step RACH procedure. In one aspect, in a unified design, a common timing advance (TA) based on a reference point in a satellite beam or cell may be used as the RAR window offset for all UEs. In one aspect, a common TA may be used as the RAR window offset for all UEs without location information. The UE may send Msg1 in the 4-step RACH procedure or MsgA in the two-step RACH procedure with the common TA. In one aspect, a full TA that accounts for the UE-specific propagation delay may be set as the RAR window offset for UEs with location information. The UE may send Msg1 or MsgA with the full TA.

In one aspect, for the 2-step RACH procedure, the base station may blindly retransmit MsgB within the RAR window that is nominally at 40 ms to maintain reliable transmission of MsgB for NTN. This is because for NTN, the large propagation delay may make HARQ-ACK retransmission difficult in the RAR window. MsgB-RNTI may be set equal to (1+s_id+14×t_id+14×80×f_id+14×80×8×ul_carrier_id+14×80×8×2). In one aspect, the number of blind retransmissions and/or the retransmission pattern may depend on the PRACH reception condition or the PUSCH reception condition. In one aspect, the retransmission pattern may be pre-configured.

In one aspect, the base station may extend the values of K1 and K2 that determine the delays between uplink and downlink transmissions to align the time domain duplex (TDD) uplink-downlink configuration due to the long propagation delays associated with the NTN. For example, K1 may be the time gap in unit of slots between PDSCH and the corresponding PUCCH with HARQ feedback. K1 may be indicated by the parameter “dl-DataToUL-ACK” in the information clement “PUCCH-config.” The maximum value of K1 may be nominally 15 slots. K2 may be the time gap in unit of slots between DCI reception and the corresponding PUSCH scheduled by the DCI. K2 may be indicated by the parameter “k2” in the information element “PUSCH-TimeDomain ResourceAllocation.” The maximum value of K2 may be nominally 32 slots. PUSCH and PUCCH transmission time scheduled by DCI may be indicated by K1 and K2.

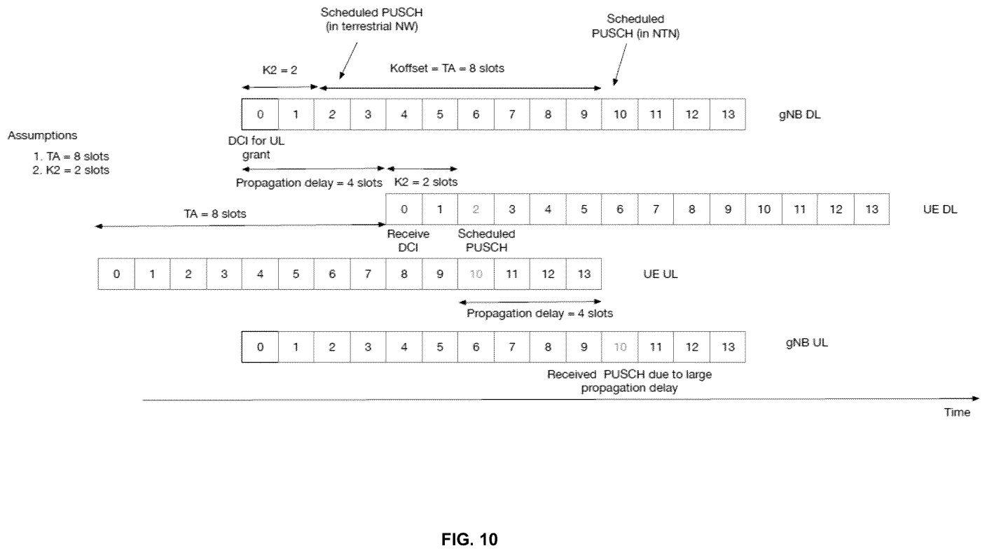

FIG. 10 illustrates a timing relationship in NTN between the base station and the UE using a timing advance adjustment for the UE based on the round trip propagation delay between the base station and the UE. In NTN, an additional offset K_{offset} may be added to the PUSCH or PUCCH transmission. For example, in FIG. 10, the one-way propagation delay between the UE and the base station is 4 slots, yielding a round-trip propagation delay of 8 slots. TA may thus be set to 8 slots. When DCI for uplink grant is at slot 0 and K2 is set to 2 by the DCI, due to the 8 slots of round-trip propagation delay, the scheduled PUSCH may not be received by the base station until slot 10. The additional offset K_{offset} may be used to adjust the PUSCH. However, depending on the additional time offset K_{offset}, the resulting slot for PUSCH or PUCCH transmission may coincide with a downlink slot. In one aspect, to align the delayed PUSCH or PUCCH transmissions with uplink slots, the maximum value of K1 may be extended to 31 slots and the maximum value of K2 may be extended to 64 slots.

In one aspect, the base station may broadcast new RAR window values to the UEs to extend the RAR window size based on if the satellite is an LEO, GEO, or others. In one aspect, the base station may broadcast the new RAR window values using system information block type 1 (SIB1). In one aspect, a new SIB1 information element may be used or a current information clement such as ‘RACHConfigCommon IE’ may be used by adding a new element for NTN.

In one aspect, the new RAR window values may be set to the same value. In one aspect, the RAR window values may be set based on the tracking area, which may be linked to the type of satellites used. In one aspect, the RAR window value may be set based on the current load and network processing capabilities to ensure that other parameters are also appropriately extended. This may include an estimation of how long the delay in response from the network may be for MsgB in the 2-step RACH procedure or for Msg2/4 in the 4-step RACH procedure and what actions the UE may take during the intermediate sleep duration.

In one aspect, the base station may multicast the new RAR window size values using page messages. Since the page message is less frequent compared to the SIB1 used for broadcast messages, the network may not be able to respond to significant spikes in the network access traffic. The page message size may need to be increased to include additional information for the new RAR window size values. However, network efficiency may be achieved because only UEs to which the page message is targeted will utilize the additional information element and not all UEs in the NTN will modify their RACH behavior. In one aspect, the page message may be restricted for only downlink traffic so that UEs that may perform the RACH procedure due to uplink traffic may not utilize this enhancement. In one aspect, any downlink page targeted at a UE may carry the new window size values instead of using of a multicast for all UEs. In one aspect, the page message may be restricted to UEs that satisfy a particular international mobile subscriber identity (IMSI).

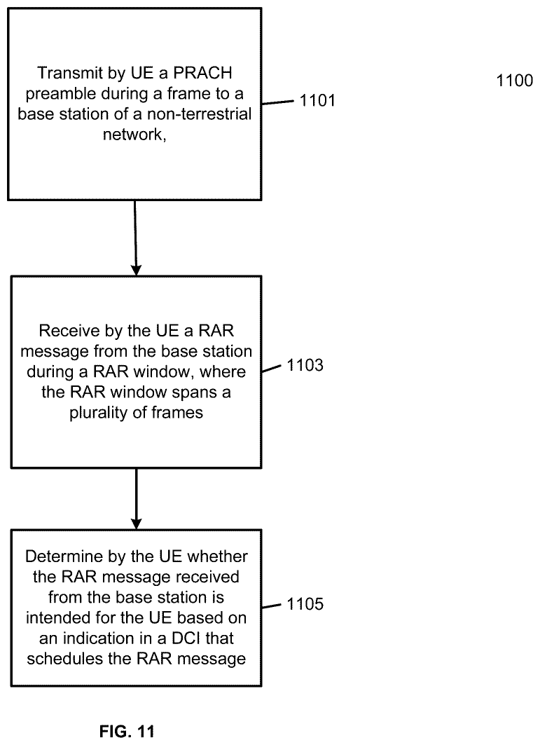

FIG. 11 is a data flow diagram illustrating an example of a method for a UE to transmit PRACH preamble to a base station and to receive a RAR message from the base station over an extended RAR window to perform the RACH procedure in accordance with some aspects of the disclosure.

At operation 1101, the UE transmits to a base station of a NTN a PRACH preamble during a frame of a frame structure that includes a plurality of frames to request access to the NTN.

At operation 1103, the UE receives a random access response RAR message from the base station during a RAR window, where the RAR window spans a plurality of frames of the frame structure.

At operation 1105, the UE determines whether the RAR message received from the base station is intended for the UE based on an indication in a downlink control information (DCI) that schedules the RAR message.

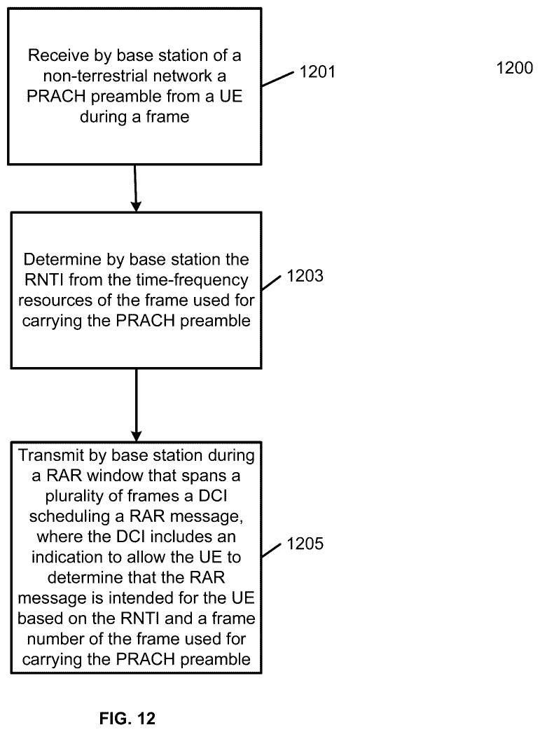

FIG. 12 is a flow diagram illustrating an example of a method for a base station to receive PRACH preamble from a UE, to determine the RNTI, and to transmit a RAR based on the RNTI over an extended RAR window to the UE in accordance with some aspects of the disclosure.

At operation 1201, the base station receives a PRACH preamble from a UE during a frame of a frame structure that includes a number of frames to request access to the NTN.

At operation 1203, the base station determines the RNTI from the time-frequency resources of the frame used for carrying the PRACH preamble.

At operation 1205, the base station transmits during a RAR window that spans a plurality of frames a DCI that schedules a RAR message. The DCI includes an indication to allow the UE to determine that the RAR message is intended for the UE based on the RNTI and a frame number of the frame used for carrying the PRACH preamble.

Aspects of the method and apparatus described herein for enhancing the RACH procedure in a wireless communication network may be implemented in a data processing system, for example, by a network computer, network server, tablet computer, smartphone, laptop computer, desktop computer, other consumer electronic devices or other data processing systems. In particular, the operations described are digital signal processing operations performed by a processor that is executing instructions stored in one or more memories. The processor may read the stored instructions from the memories and execute the instructions to perform the operations described. These memories represent examples of machine readable non-transitory storage media that can store or contain computer program instructions which when executed cause a data processing system to perform the one or more methods described herein. The processor may be a processor in a local device such as a smartphone, a processor in a remote server, or a distributed processing system of multiple processors in the local device and remote server with their respective memories containing various parts of the instructions needed to perform the operations described.

While certain exemplary instances have been described and shown in the accompanying drawings, it is to be understood that these are merely illustrative of and not restrictive on the broad aspects of the disclosure, and that this disclosure is not limited to the specific constructions and arrangements shown and described, since various other modifications may occur to those of ordinary skill in the art. The description is thus to be regarded as illustrative instead of limiting.

What is claimed is:

1. A method by a base station in a non-terrestrial communication network, the method comprising:
receiving, by the base station, from a user equipment (UE), a physical random access channel (PRACH) preamble during a frame of a frame structure that includes a plurality of frames to request access to the non-terrestrial communication network;
determining, by the base station, a radio network temporary identifier (RNTI) from time-frequency resources of the frame used for carrying the PRACH preamble; and
transmitting, by the base station during a random access response (RAR) window that spans a plurality of the frames, a downlink control information (DCI) scheduling a RAR message, wherein the DCI includes an indication to allow the UE to determine that the RAR message is intended for the UE based on the RNTI and a frame number of the frame used for carrying the PRACH preamble.

2. The method of claim 1, wherein transmitting the RAR message during the RAR window that spans a plurality of frames comprises:
transmitting repeatedly the RAR message for a plurality of frames of the RAR window.

3. The method of claim 2, wherein a number of the frames used for transmitting the RAR message is a function of a channel condition measured when receiving the PRACH preamble.

4. The method of claim 2, further comprising:
receiving, by the base station from the UE, uplink data carried on a second set of time-frequency resources after the PRACH preamble,
and wherein a number of the frames used for transmitting the RAR message is a function of a channel condition measured when receiving the uplink data.

5. The method of claim 2, wherein a number and a pattern of the frames used for transmitting the RAR message is pre-configured.

6. The method of claim 1, further comprising:
broadcasting by the base station a number of the frames that span the RAR window.

7. The method of claim 6, wherein the number of the frames that span the RAR window is a fixed value.

8. The method of claim 6, further comprising:
determining the number of frames that span the RAR window based on a coverage area of the base station.

9. The method of claim 6, further comprising:
determining the number of frames that span the RAR window based on a processing load and a processing capability of the communication network.

10. The method of claim 1, wherein the RAR window spans two frames, and wherein the indication of the DCI identifies the frame number of the frame used for carrying the PRACH preamble as an even frame or an odd frame.

11. The method of claim 1, wherein the RAR window spans two frames, and wherein the RNTI is determined based on the time-frequency resources and an odd frame or an even frame of the frame number of the frame used for carrying the PRACH preamble.

12. The method of claim 1, wherein the RAR window spans two frames, and wherein a portion of a cyclic redundancy check (CRC) of the DCI is masked with the RNTI, wherein the portion of the CRC of the DCI masked is identified by an odd frame or an even frame of the frame number of the frame used for carrying the PRACH preamble.

13. The method of claim 1, wherein a start of the RAR window is offset from an end of the PRACH preamble by a timing advance (TA) value that is adaptable to align the frame structure between the UE and the base station.

14. The method of claim 1, wherein receiving from the UE the PRACH preamble comprises:
receiving repeatedly from the UE the PRACH preamble carried on identical time-frequency resources of a plurality of frames of the frames structure.

15. A baseband processor of a base station configured to perform operations comprising:
receive from a user equipment (UE) of a non-terrestrial communication network a physical random access channel (PRACH) preamble during a frame of a frame structure that includes a plurality of frames to request access to the non-terrestrial communication network;
determine a radio network temporary identifier (RNTI) from time-frequency resources of the frame used for carrying the PRACH preamble; and
transmit, during a random access response (RAR) window that spans a plurality of the frames, a downlink control information (DCI) scheduling a RAR message, wherein the DCI includes an indication to allow the UE to determine that the RAR message is intended for the UE based on the RNTI and a frame number of the frame used for carrying the PRACH preamble.

16. The baseband processor of claim 15, wherein the operations to transmit the RAR message during the RAR window that spans a plurality of frames comprises operations to:
transmit repeatedly the RAR message for a plurality of frames of the RAR window.

17. The baseband processor of claim 16, wherein a number of the frames used to transmit the RAR message is a function of a channel condition measured when receiving the PRACH preamble.

18. The baseband processor of claim 16, wherein the operations further comprise:
receive from the UE uplink data carried on a second set of time-frequency resources after the PRACH preamble, and
and wherein a number of the frames used to transmit the RAR message is a function of a channel condition measured when receiving the uplink data.

19. The baseband processor of claim 16, wherein a number and a pattern of the frames used for transmitting the RAR message is pre-configured.

20. The baseband processor of claim 15, wherein the operations further comprise:
broadcast a number of the frames that span the RAR window.

21. The baseband processor of claim 20, wherein the number of the frames that span the RAR window is a fixed value.

22. The baseband processor of claim 20, wherein the operations further comprise:
determine the number of frames that span the RAR window based on a coverage area of the base station.

23. The baseband processor of claim 20, wherein the operations further comprise:
determine the number of frames that span the RAR window based on a processing load and a processing capability of the communication network.

24. The baseband processor of claim 15, wherein the RAR window spans two frames, and wherein the indication of the DCI identifies the frame number of the frame used for carrying the PRACH preamble as an even frame or an odd frame.

25. The baseband processor of claim 15, wherein the RAR window spans two frames, and wherein the RNTI is determined based on the time-frequency resources and an odd frame or an even frame of the frame number of the frame used for carrying the PRACH preamble.

26. The baseband processor of claim 15, wherein the RAR window spans two frames, and wherein a portion of a cyclic redundancy check (CRC) of the DCI is masked with the RNTI, wherein the portion of the CRC of the DCI masked is identified by an odd frame or an even frame of the frame number of the frame used for carrying the PRACH preamble.

27. The baseband processor of claim 15, wherein a start of the RAR window is offset from an end of the PRACH preamble by a timing advance (TA) value that is adaptable to align the frame structure between the UE and the base station.

28. The baseband processor of claim 15, wherein the operation to receive from the UE the PRACH preamble comprises operations to:
receive repeatedly from the UE the PRACH preamble carried on identical time-frequency resources of a plurality of frames of the frames structure.

29. A base station device comprising:
at least one antenna;
at least one radio, wherein the at least one radio is configured to communicate with a user equipment (UE) of a non-terrestrial communication network using the at least one antenna; and
at least one processor coupled to the at least one radio, wherein the at least one processor is configured to perform operations comprising:
receive from the UE a physical random access channel (PRACH) preamble during a frame of a frame structure that includes a plurality of frames to request access to the non-terrestrial communication network;
determine a radio network temporary identifier (RNTI) from time-frequency resources of the frame used for carrying the PRACH preamble; and
transmit during a random access response (RAR) window that spans a plurality of the frames a downlink control information (DCI) scheduling a RAR message, wherein the DCI includes an indication to allow the UE to determine that the RAR message is intended for the UE based on the RNTI and a frame number of the frame used for carrying the PRACH preamble.
